(19) United States
(12) Patent Application Publication
(10) Pub. No.: US 2003/0214483 A1
(43) Pub. Date: Nov. 20, 2003

(54) Foot control mechanism for computer mouse

(76) Inventors: Douglas A. Hammer, Fallbrook, CA (US); Lance Hopkins, Fallbrook, CA (US)

Correspondence Address: MURPHEY & MURPHEY, A.P.C., 701 PALOMAR AIRPORT ROAD, SUITE 260, CARLSBAD, CA, 92009, US

(21) Appl. No.: 10/146,637

(22) Filed: May 14, 2002

(51) Int. Cl. G09G 5/08

(52) U.S. Cl. 345/163

(57) ABSTRACT

A foot control for a computer mouse-computer pad combination, to move a computer cursor around the computer display monitor including two foot pedals in spaced-apart arrangement, each foot pedal having a centralized neutral position, arranged for movement therefrom through and into two other positions by pressure applied from separate areas of each foot, a harness for holding one part of a computer mouse-computer pad combination and moving the harness about a flat plane, and a series of pulleys and wires interconnecting the foot pedals with the harness to provide north-south, east-west, oblique and curved movements of the harness about the plane with movement of the foot pedals.

### BACKGROUND OF THE INVENTION

1. Field of the Invention

This invention pertains to the field of computers. More particularly, it pertains to a foot control mechanism for moving the computer mouse over the mouse pad thereby relieving the user's hand from the task of moving from the key pad in order to move the mouse.

2. Description of the Prior Art

I have a mouse, he has no face nor legs but just a tail,

He works for me around the clock and never seems to fail,

I move him 'round his little pad and watch him go and play,

Pets may come and pets may go, but my mouse's here to stay. Anon, 2002

The above words show the importance of the computer mouse. There is probably no one left in the developed world who isn't familiar with the modem day computer. Along with this knowledge is the recognition of the role played by the computer mouse. The small, egg-sized mouse sits on its pad, generally adjacent the computer keyboard, and, when moved by the user's hand, causes the cursor to move about the computer screen.

The mouse historically has been an appendage to the computer and, when using it, requires the user to take one hand off the keyboard, place it over the mouse, and move the mouse on its pad and click one or more keys on the mouse before returning their hand to the keyboard. Some effort has been made to allow the mouse on the computer pad to be moved by one's finger or finger nail; however, this operation still requires lifting one's hand from the keyboard.

Should the mouse be relocated such that its use does not require the hand to be lifted from the keyboard, the user would be able to type longer and produce more computer product, whether it is composing a business letter, a complex design or playing a game.

### SUMMARY OF THE INVENTION

This invention is a foot control for the computer mouse. It uses movement of one or both feet on the controls to move the cursor about the computer screen. In one embodiment, the clickable switches, normally found on the mouse, are relocated to the keyboard where the user may select them just as is selecting other items on the computer. In another embodiment, one foot controls movement of the cursor about the computer screen while the other foot operates switches that are normally found on the mouse. In all cases, the operator is relieved of the task of removing his or her hand from the keyboard to operate the mouse.

Accordingly, the main object of this invention is the relocation of the mouse from adjacent the computer keyboard to the area surrounding the feet of the computer user and elimination of the task to move one's hand from the keyboard to the mouse in order to direct the cursor on the computer screen.

These and other objects of the invention will become more clear when one reads the following specification, taken together with the drawings that are attached hereto. The scope of protection sought by the inventor may be gleaned from a fair reading of the Claims that conclude this specification.

### DESCRIPTION OF THE DRAWINGS

FIG. 1 is a perspective view of one of the embodiments of this invention showing use of two pedals to move the cursor and show some of the mechanical elements used to connect foot pedal movement to movement of the cursor;

FIG. 2 is a side view of the pitching motion of the preferred embodiment of the foot pedals of this invention;

FIG. 3 is an end view of the rolling motion of another embodiment of the foot pedals of this invention;

FIG. 3a is a top view of a person's foot on a foot pedal showing the alignment of central rolling axis x²-x²;

FIG. 4 is a top view of the yawing motion of another embodiment of the foot pedals of this invention;

FIG. 5 is a side view of the harness that holds one element of the two element combination of a computer mouse and a computer mouse pad showing the harness to be holding the mouse;

FIG. 6 is another view of the harness showing it to be holding the mouse pad;

FIG. 7 is another view of the harness showing it to be holding the mouse where the mouse pad is resting on an independent surface and not part of the claimed invention;

FIG. 8 is a top view of the embodiment shown in FIG. 1, with a few parts removed for clarity, showing the mechanical means for moving the cursor by movement of the foot pedals;

FIG. 8a is a perspective view of the right side of the embodiment shown in FIG. 8 showing a close-up view of the right side foot pedal and the pulleys and lines strung thereabout and connected to certain elements;

FIG. 8b is a perspective view of the left side foot pedal and the pulleys and lines strung thereabout and connected to certain elements;

FIG. 9 is a front view of the face of a computer monitor showing the movement of the cursor as driven by the food pedals of this invention;

FIG. 10 is an illustrative view of the electrical means of driving the cursor with the foot pedals, in a pitching embodiment of this invention, where the means includes a variable resistance;

FIG. 11 is an illustrative view of the mechanical-electrical means of driving the cursor with the foot pedals, in a yawing embodiment of this invention, where the means includes a variable capacitor;

FIG. 12 is an illustrative view of the electrical means of driving the cursor with the foot pedals, in a pitching embodiment of this invention, where the means includes a variable voltage divider;

FIG. 13 is an illustrative view of the electrical means of driving the cursor with the foot pedals, in a pitching and a yawing embodiment of this invention, where the means includes a variable capacitor and a voltage divider; and,

FIG. 14 is an illustrative view of one of the foot pedals in a pitching embodiment where the foot pedal is used to actuate an electric switch similar to the electric switch presently on a mouse.

### DESCRIPTION OF THE PREFERRED EMBODIMENT

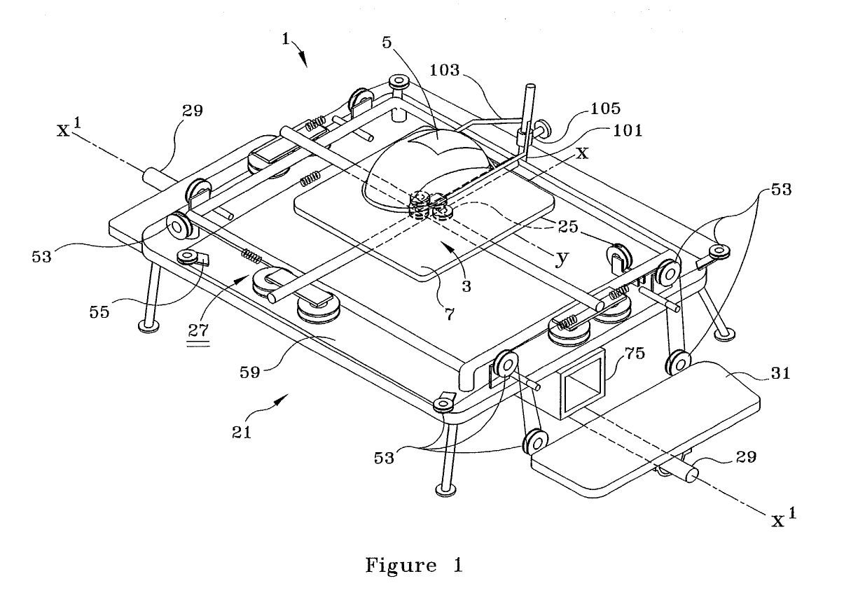

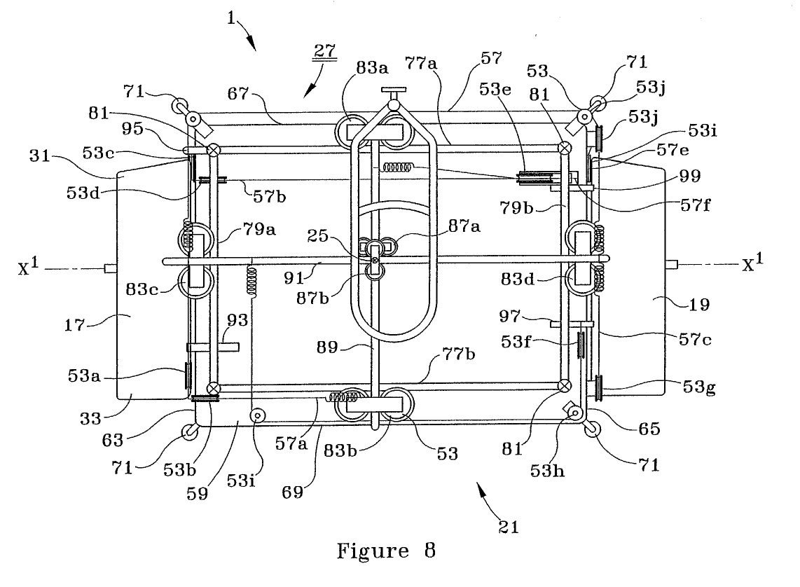

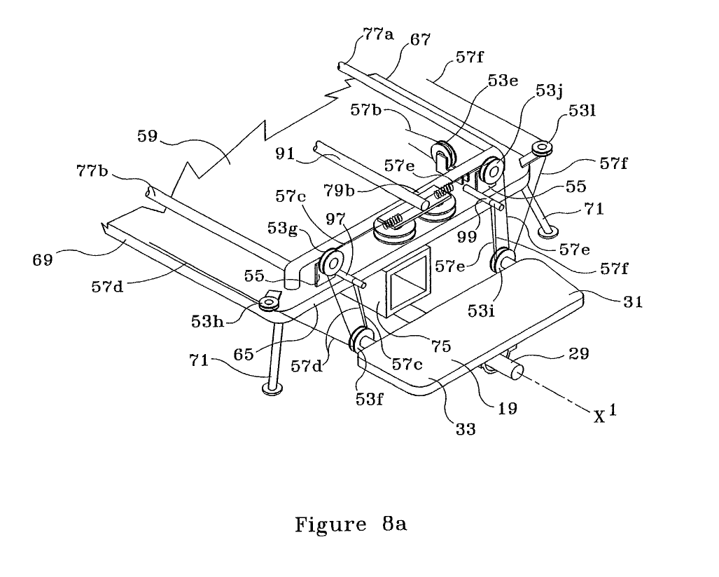

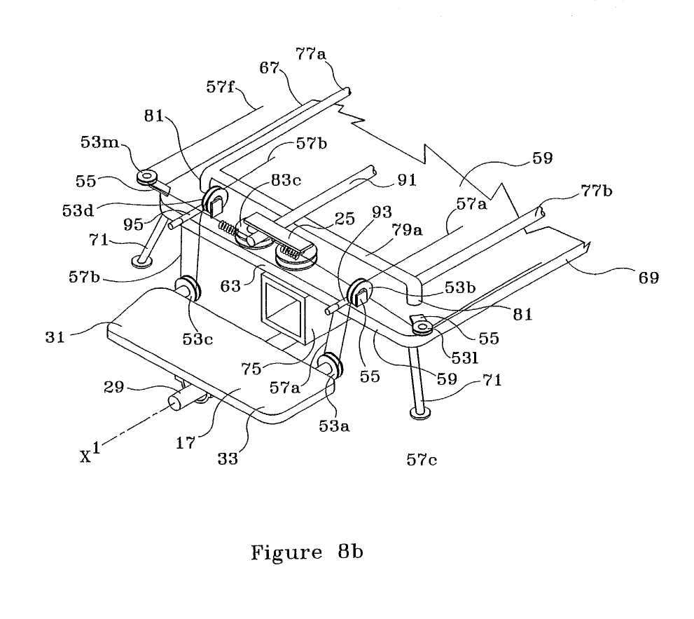

Turning now to the drawings, where elements are identified with numbers and like elements are identified with like numbers throughout the 17 drawings, FIGS. 1 to 17 show a number of different embodiments of the invention. FIGS. 1 and 8 show a foot control 1 for moving one part of a combination 3 of a computer mouse 5 and mouse pad 7, to move a computer cursor 9 around the face 13 of a computer monitor 15 of a computer assembly (see FIG. 9). This embodiment of the invention comprises two foot pedals, 17 and 19, in spaced-apart arrangement on a base 21 where base 21 is preferably located between the pedals. The term “foot pedal” as used herein defines an elongated pedal spanning from near the heel to near the toe of the user's foot or shoe placed thereon. Foot pedals 17 and 19 may vary in length, however, they need to be long enough to react to the movement of the pitch, yaw and roll of the foot placed thereon, as will be discussed later.

A harness 25 is provided for holding one element of computer mouse-mouse pad combination 3, i.e., either mouse 5 or pad 7. Whichever element of combination 3 is held by harness 25, the other element is located in close proximity thereto to allow the two elements, namely mouse 5 and pad 7, to contact each other as in the ordinary use of a mouse with a pad.

Means 27 is provided for interconnecting foot pedals 17 and 19 with harness 25 to provide north-south, east-west, oblique and curved movements of harness 25 about a phantom plane x-y with the pivotal movement of said pedals. The terms “north-south, east-west, oblique and curved movement” are used herein to identify all the possible moves a cursor can make in its travel over or in monitor face 13.

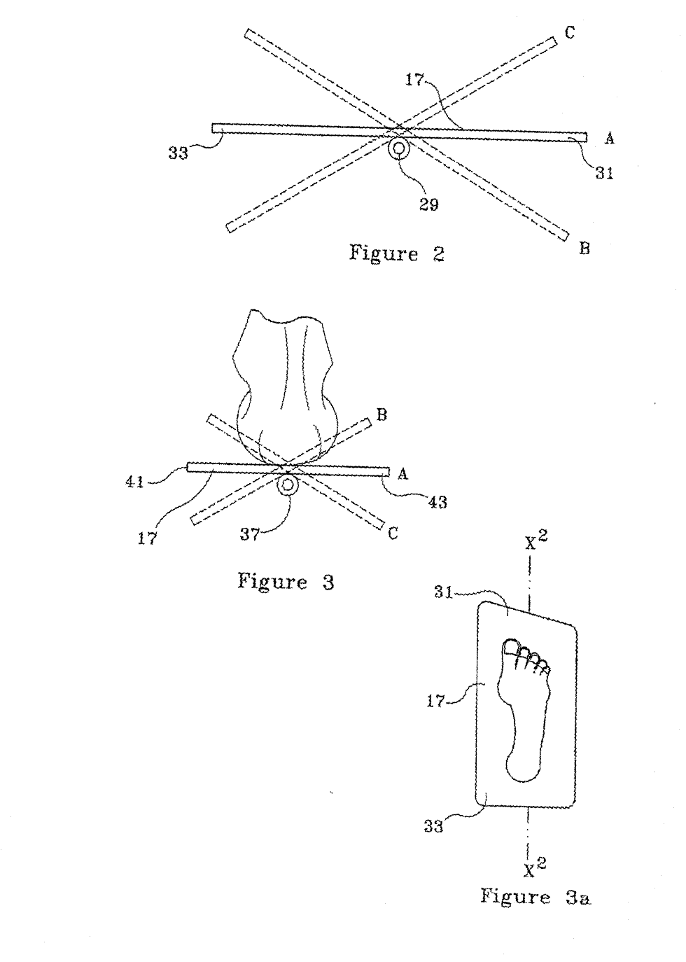

Turning to foot pedals 17 and 19, as shown in FIGS. 2, 3 and 4, each pedal has a centralized neutral position “A”, which corresponds to cursor 9 being located at the center of monitor face 13. There are at least two other positions, “B” and “C”, of the pedals.

FIG. 2 shows a first embodiment of one pedal wherein it is supported by a shaft 29, extending from base 21, aligned along a central axis x¹-x¹ (FIGS. 1, 8, 8a and 8b) transverse to the long direction of each foot pedal, thereby allowing the pedal to pitch up or down (as shown in dotted outline) at the front end 31 of the foot pedal, by pressing one's toes downward on front end 31, or allowing the pedal to tip upward at the front end 33 of the foot pedal by pressing one's heel downward on rear end 33. Full downward travel of foot pedal front end 31 is marked as position B, while full downward travel of foot pedal rear end 33 is marked as position C. As the foot pedal is moved between positions A and B, mouse 5 moves cursor 9 on monitor face 13 from center to the right or left; while between positions A and C, cursor 9 is moved on monitor face 13 from center in the opposite direction, positions B and C being the extreme edge of the monitor face 13. Thus is produced a side-to-side or “east-west” motion of cursor 9 by using a foot pedal in a pitching motion above and below of neutral position A.

By rigging the other pedal in the same general manner, downward travel of pedal front end 31, between positions A and B, moves cursor 9 on monitor face 13 from center upward while downward travel of foot pedal rear end 33, between positions A and C, moves cursor 9 on monitor face 13 in the opposite direction, positions B and C being the extreme edge of the monitor face 13. Thus is produced a top-to-bottom or “north-south” motion of cursor 9 by using the other foot pedal, also in a pitching motion, fore and aft of neutral position A. By coordinating movement of both feet on foot pedals 17 and 19, mouse 5 is able to drive cursor 9 over every part of monitor face 13.

FIG. 3 shows a second embodiment of one pedal wherein it is supported by a shaft 37, located along side base 21 on brackets 39 (see FIG. 12), along a central axis x²-x² (see FIG. 3a) aligned with the long direction of each foot pedal, thereby allowing the foot pedal to be rolled to the left by pressing the left side of the foot on the left side 41 of the foot pedal and allowing the pedal to be rolled to the right by pressing the right side of the foot on the right side 43 of the foot pedal (shown in dotted outline). Full downward travel of foot pedal left side 41 (full roll left) is marked as position B, while full downward travel of foot pedal right side 43 (full roll right) is marked as position C. As the foot pedal is moved between positions A and B, mouse 5 moves against mouse pad 7 and moves cursor 9 on monitor face 13 from center to the right or left; while between positions A and C, cursor 9 is moved on monitor face 13 from center in the opposite direction, positions B and C being the extreme edge of the monitor face 13. Thus is produced a side-to-side or “east-west” motion of cursor 9 by using a pedal in a pitching motion fore and aft of neutral position A.

By rigging the other pedal in the same general manner, left rolling travel of pedal left side 41, between positions A and B, moves cursor 9 on monitor face 13 from center upward while right rolling travel of pedal right side 43, between positions A and C, moves cursor 9 on monitor face 13 in the opposite direction, positions B and C being the extreme edge of the monitor face 13. Thus is produced a top-to-bottom or “north-south” motion of cursor 9 by using the other pedal, also in a rolling motion, side-to-side of neutral position A. By coordinating movement of both feet on foot pedals 17 and 19, cursor 9 is able to be driven over every part of monitor face 13.

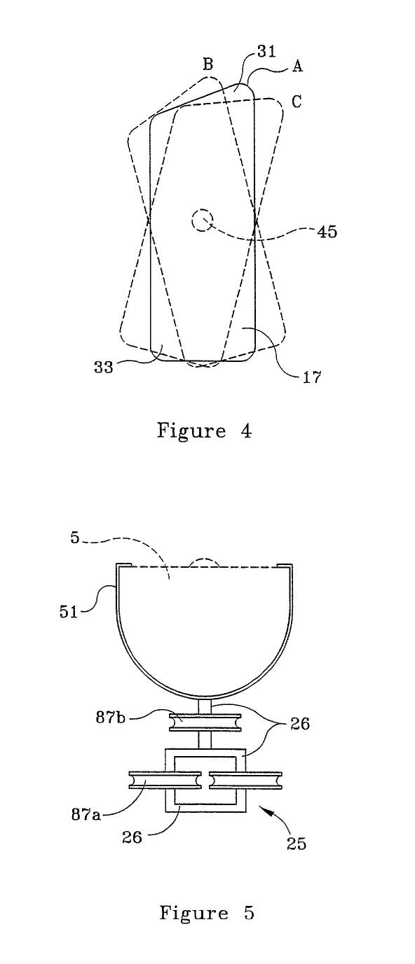

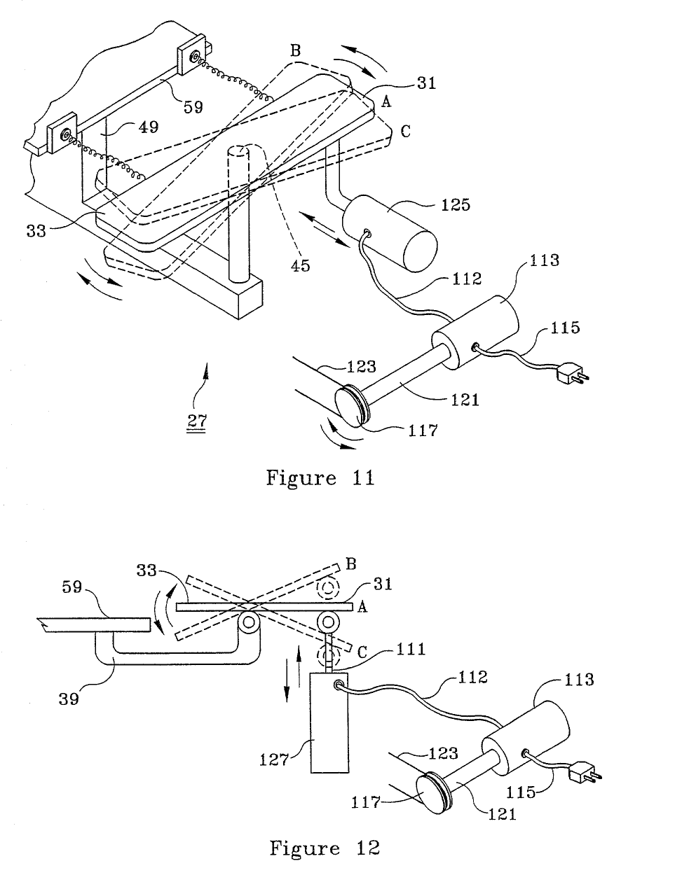

FIGS. 4 and 11 show a third embodiment of one pedal wherein it is supported by a centrally located bearing 45, supported along side base 21 on a bracket 49, thereby allowing the pedal to be yawed or rotated counter-clockwise by twisting the foot on the pedal counter-clockwise and allowing the pedal to be yawed or rotated clockwise by twisting the foot on the pedal clockwise. Full counter-clockwise rotation of the pedal (full twist left) is marked as position B, while full clockwise rotation of the pedal (full twist right) is marked as position C. As the pedal is moved between positions A and B, cursor 9 is moved on monitor face 13 from center to the right or left; while between positions A and C, mouse 5 is moved over mouse pad 7 to move cursor 9 on monitor face 13 from center in the opposite direction, positions B and C being the extreme edge of the monitor face 13. Thus is produced a side-to-side or “east-west” motion of cursor 9 by using a pedal in a pitching motion fore and aft of neutral position A.

By rigging the other pedal in the same general manner, counter-clockwise rotation of the pedal, between positions A and B, moves cursor 9 on monitor face 13 from center upward while clockwise rotation of the pedal, between positions A and C, moves cursor 9 on monitor face 13 in the opposite direction, positions B and C being the extreme edge of the monitor face 13. Thus is produced a top-to-bottom or “north-south” motion of cursor 9 by using the other pedal, also in a rotational or twisting motion, side-to-side of neutral position A. By coordinating movement of both feet on foot pedals 17 and 19, cursor 9 is able to be driven over every part of monitor face 13.

The individual movements of foot pedals 17 and 19 can be mixed for various reasons. For instance, instead of having both pedals 17 and 19 operate in a pitching motion about separate transverse shafts 29, one pedal can be so rigged while the other pedal can be rigged to yaw left and right on bearing 45 or rolled clockwise or counter clockwise about axial shaft 37. Instead of both pedals 17 and 19 operate in a yawing motion about separate bearings 45, one pedal can be so rigged while the other pedal can be rigged to operate in a pitching motion about one transverse shaft 29 or rolled to the left or to the right about pivotal shaft 41. Instead of both pedals 17 and 19 operating in a rolling motion, one pedal can be so rigged while the other pedal can be rigged to operate in a pitching motion about one transverse shaft 29 or the other pedal can be rigged to yaw left and right on bearing 45. Any combination of these three types of pedal movement can be arranged to produce full travel of cursor 9 over the entire face 13 of the monitor.

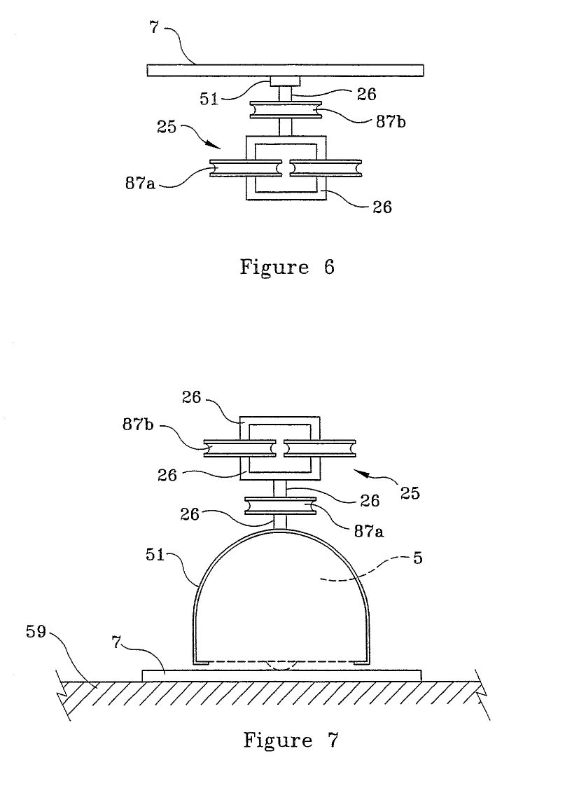

As shown in FIG. 5, harness 25 is preferably arranged to hold mouse 5, of computer mouse-mouse pad combination 3, as it traverses mouse pad 7, also mounted on base 21 with the aid of a clip 51. In another embodiment, shown in FIG. 6, harness 25 is arranged to hold mouse pad 7 on base 21 with the aid of clip 51. As shown in FIG. 7, mouse pad 7 need not be made a part of foot control 1 or base 21 and harness 25 and clip 51 can be rigged to hold mouse 5 and move it about mouse pad 7 such as when mouse pad 7 is already supported on another surface such as the floor.

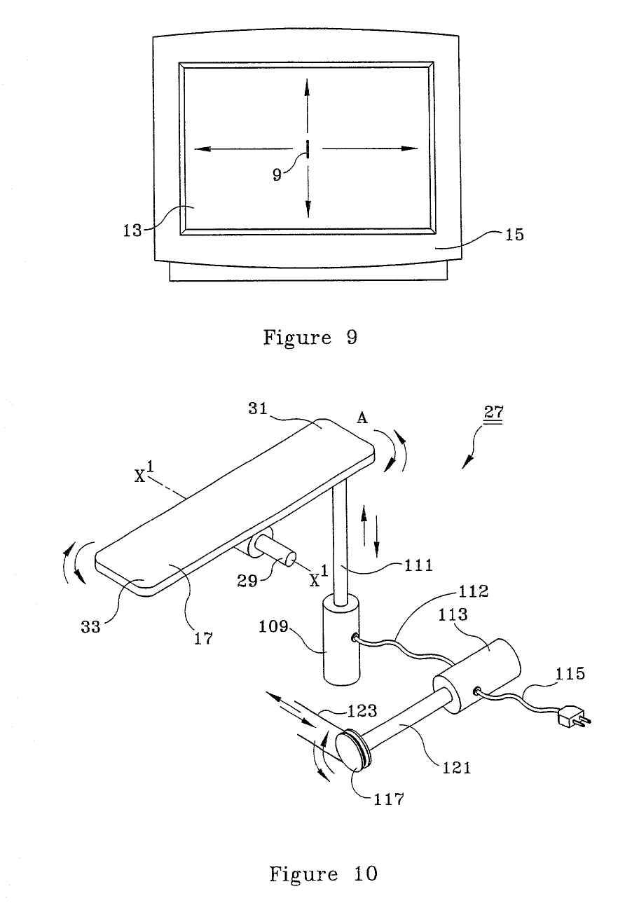

As shown in FIGS. 10 through 14, means 27, interconnecting foot pedals 17 and 19 with harness 25, to provide north-south, east-west, oblique and curved movements of harness 25 about plane x-y, driven by the pivotal movement of said pedals, can be mechanical means, electrical means, or a combination of both mechanical and electrical means.

As shown in FIGS. 1, 8, 8a and 8b, base 21 is located between foot pedals 17 and 19 for supporting harness 25, for holding one part of a computer mouse-mouse pad combination 3, and for moving harness 25 about flat plane x-y. A plurality of pulleys 53 are mounted on base plate 59 by clips 55 that anchor them for rotational movement. At least one flexible line 57 is attached to pedals 17 and 19, as well as to harness 25, and arranged to move over pulleys 53 and about base 21, powered by foot pedals 17 and 19, to reposition harness 25 vis-a-vis flat plane x-y as a function of the movement of said pedals.

Base plate 59 is shown in FIGS. 1, 8, 8a, and 8b to include a base plate 59 defined by opposed, side edges 63 and 65, respectively, and spaced-apart front and rear edges 67 and 69 respectively. Four legs 71 extend downward from the four corners of base plate 59 to support base 21 on a planar surface. A bar 75 passes under plate 59 and from side-to side and supports a pair of mutually or outwardly extending transverse shafts 29 on which foot pedals 17 and 19 are pivotally mounted. On top of base plate 59 are mounted two pairs of spaced-apart rails, 77a-77b and 79a-79b fixed above the surface of plate 59 by pylons 81 mounted thereon and connected to the respective terminal ends of said rails. Rail pair 77a-77b is arranged laterally cross plate 59 while rail pair 79a-79b is arranged longitudinally cross plate 59.

Four pairs of first rollers 83a, 83b, 83c, and 83d, are mounted on fixed rails 77a, 77b, 79a and 79b each pair of said rollers held by harness 25 and interconnected short stubs 26. Two pairs of second rollers 87a and 87b are mounted on cross members 89 and 91. Pairs of second rollers 87a and third rollers 87b are attached together by another harness 25 (including short stubs 26), in orthogonal arrangement, and are in rotational contact with cross members 89 and 91, for travel therealong. A first flexible line 57a passes from a stop 93, mounted on base plate 59 near left side edge 63 around a first pulley 53a, mounted to rear end 33 of left pedal 17, upward, over a second pulley 53b and over to moveable cross-member 89. Each connection of a line 57 with a pair of rollers and harnesses includes a small spring at the end of the line to maintain tension. A second flexible line 57b passes from a stop 95, mounted on base plate 59 near left side edge 63 and around a third pulley 53c, mounted to front end 31 of left pedal 17, upward over a fourth pulley 53d, and a fifth pulley 53e located on the right side of plate 59) and back over to moveable cross-member 89. Pitching motion of pedal 17 about transverse shaft 29 and about axis x¹-¹ causes lines 57a and 57b to push and pull moveable cross-member 89 and harness 25 laterally along rails 77a-77b and move second pair of rollers 87a side-to-side or “east-and-west” over base plate 59.

A third flexible line 57c passes from a stop 97, mounted on base plate 59 near right side edge 65, around a sixth pulley 53f, mounted to the rear end 33 of foot pedal 19, upward over a seventh pulley 53g, and over to moveable cross-member 91 along base plate right side 65. A fourth flexible line 57d passes from stop 97 around pulley 53f upward over an eighth pulley 53h, across base plate 59 to a ninth pulley 53i and forward to cross- member 91. A fifth flexible line 57e passes from a stop 99, mounted on base plate 59 near right side edge 65, around a tenth pulley 53j, mounted to front end 31 of pedal 19 and down to cross-member 91. A sixth flexible line 57f passes from stop 99 around pulley 53i upward and over a twelfth pulley 531, across base plate 59 to a thirteenth pulley 53m and downward to moveable cross-member 91. Pitching motion of pedal 19 about transverse shaft 29 causes lines 57c, 57d, 57e and 57f to push and pull moveable cross-member 91 and harness 25 longitudinally along rails 79a-79b and move third pair of rollers 87a up and down or “north-south” over base plate 59.

A stanchion 101 is shown in FIGS. 1 and 8 mounted to base plate 59, along base plate front edge 67, and extending upward, above moveable cross-members 89 and 91. As shown in Figure a clamp 103 extends from stanchion 101 outward over base plate 59 and is arranged to hold computer mouse 5 stationary, over base plate 59. An adjustment fixture 105 is provided on stanchion 101 to allow clamp 103 to be raised or lowered at will. Mouse 5 is shown in FIG. 1 fixedly mounted in clamp 103 and mouse pad 7 mounted on harness 25 so that mouse pad 7 is moved about in a level plane under mouse 5 and in contact with it. Mouse 5 is shown in FIG. 5 mounted on a clip 51 that is attached to harness 25 and mouse pad 7 is shown fixedly mounted in clamp 103. In this configuration, mouse pad 7 is fixedly held and mouse 5 is moved thereunder in a level plane. In FIG. 7, Mouse pad 7 is shown merely sitting on a flat surface, such as base plate 59, and mouse 5 is mounted in clip 51 attached to harness 25 so that mouse 5 is moved about mouse pad 7. The switches (buttons) presently located on mouse 5 can easily be re-located on the computer keyboard such as in the Function Keys.

As described, pitching of left foot pedal 17 causes mouse pad 7 to move in a side-to-side, east-west motion while pitching of right foot pedal 19 causes mouse pad 7 to move in an up-down, north-south motion. By coordinated motion of both pedals, mouse 5 can be controlled to move cursor 9 about the entire surface of monitor face 13. Foot control 1 may be modified to have mouse 5 held on top of harness 25 and aligned on plane x-y and clamp 103 arranged to hold mouse pad 7 in operable planar contact with it.

Means 27 is provided for interconnecting foot pedals 17 and 19 with harness 25 to provide north-south, east-west, oblique and curved movements of harness 25 about a phantom plane x-y with the pivotal movement of said pedals. As shown in FIG. 10, means 27 comprises a variable resistance pot 109, connected to a shaft 111 extending downward from foot pedal front end 31 (or rear end 33) for movement there is as shown by the arrows. Variable resistance pot 109 is electrically connected by a line 112 to a reversible electric motor 113 (the reversible motion shown by the arrows), powered through an electrical supply wire 115 to a source of electric power (not shown). A pulley 117 is fastened onto the motor output shaft 121 that moves a flexible line 123 (which could be any of the flexible lines 57a, et sec.) forward and backward as shown by the arrows all pursuant to the position (pitch, yaw or roll) of the foot pedal away from its neutral position A and toward positions B and C. Line 123 is connected as previously described and is ultimately connected to either mouse 5 or mouse pad 7, to move one against the other, in an east-west direction (or a north-south direction) depending upon the position of the foot pedal from its neutral position A. Upon movement of the foot pedal, the resistance is changed in pot 109 and motor 113 is commanded to move forward or in reverse a precise distance to control the position of cursor 9 on monitor face 13. Further discussion of this aspect of the invention is not warranted because connecting a variable resistance to a reversible electric motor, in an electromechanical drive, is well within the prior art.

As shown in FIG. 11, means 27 comprises a variable capacitance pot 125, connected to shaft 111 extending sideways from foot pedal front end 31 (or rear end 33) for movement therein as shown by the arrows. Variable capacitance pot 125 is electrically connected by line 112 to reversible electric motor 113 (the reversible motion shown by the arrows), powered through electrical supply wire 115 to the source of electric power (not shown). Pulley 117 on motor output shaft 121 moves flexible line 123 forward and backward, pursuant to the position (pitch, yaw or roll) of the foot pedal away from its neutral position A and toward positions B and C. Line 123, to either mouse 5 or mouse pad 7, moves one against the other, in an east-west direction (or a north-south direction) depending upon the position of the foot pedal from its neutral position A. Upon movement of the foot pedal, the capacitance in pot 125 is changed in the circuit and motor 113 is commanded to move forward or in reverse (as shown by the arrows) a precise distance to control the position of cursor 9 on monitor face 13. Further discussion of this aspect of the invention is not warranted because connecting a variable capacitance to a reversible electric motor, in an electric-mechanical drive, is well within the prior art.

As shown in FIG. 12, means 27 comprises a variable voltage divider 127, connected to shaft 111 extending downward from foot pedal front end 31 (or rear end 33). Variable voltage divider 127 is electrically connected by line 112 to reversible electric motor 113, powered through electrical supply wire 115 to the source of electric power (not shown). Pulley 117 on motor output shaft 121 moves flexible line 123 forward and backward, pursuant to the position (pitch, yaw or roll) of the foot pedal away from its neutral position A and toward positions B and C. Line 123, ultimately connected to either mouse 5 or mouse pad 7, moves one against the other, in an east-west direction (or a north-south direction) depending upon the position of the foot pedal from its neutral position A. Upon movement of the foot pedal, the voltage in voltage divider 127 is changed and motor 113 is commanded to move forward or in reverse a precise distance to control the position of cursor 9 on monitor face 13. Further discussion of this aspect of the invention is not warranted because connecting a voltage divider to a reversible electric motor, in an electromechanical drive, is well within the prior art. As all three of these electrical devices, i.e., variable resistance 109, variable capacitance 125, and voltage divider 127 utilize flexible line 123, springs and pulleys, they may be referred to as “electrical means” or “electromechanical means”.

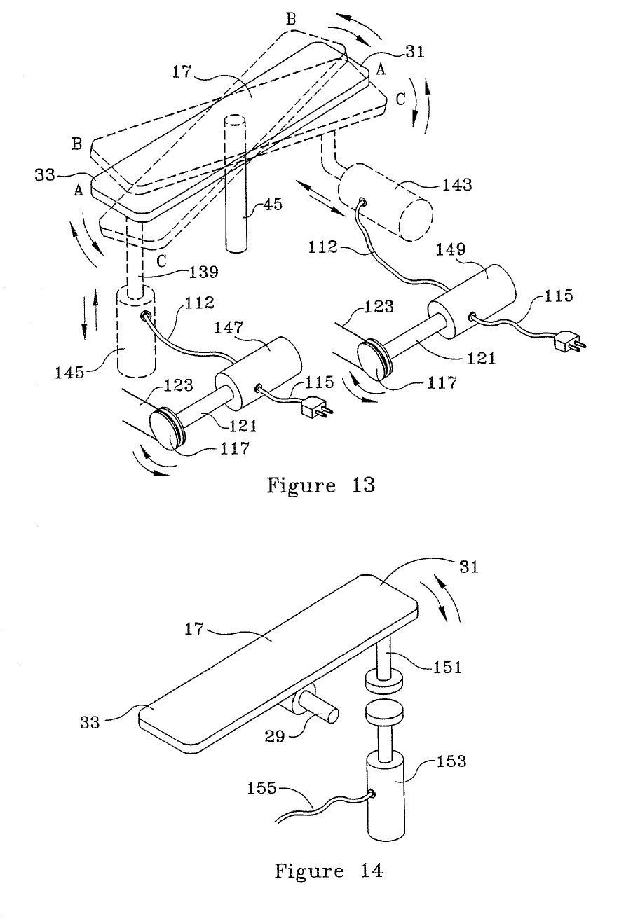

A second embodiment of foot control 1 is shown in FIG. 13 to comprise a single foot pedal 17 mounted on a centralized bearing 45 having a centralized neutral position A. First and second arms 137 and 139 extend from the underside of foot pedal 17 into variable resistance pots 143 and 145 respectively. Arm 137 extends from foot pedal front end 31 and arm 135 extends from foot pedal left side 41. Variable resistance pots 143 and 145 are electrically connected by line 112 to reversible electric motors 147 and 149, powered through an electrical supply wire 115 to a source of electric power (not shown). Pulley 117 is fastened onto the motor output shafts 121 of each motor that moves flexible lines 123 forward and backward pursuant to the position of foot pedal 17 away from its neutral position A and toward positions B or C. Lines 123 are connected as previously described, however, foot pedal 17 operates about two axes, transverse and longitudinal. Pitching foot pedal 17 up and down causes arm 137 to vary the resistance going to motor 149 and control the east-west travel of cursor 9 across monitor face 13 while rolling foot pedal 17 from side-to-side causes arm 139 to vary the resistance going to motor 147 and control the north-south travel of cursor 9 across monitor face 13. To maintain its neutral position at location A, one or more springs or other bias instruments 155 may be used as shown in FIG. 11.

This latter embodiment is a one-foot pedal operation to move cursor 9 in all directions. The other foot pedal may be used to activate switches presently found on computer mouses. FIG. 14 shows foot pedal 17 pivoted about transverse axle 29 and having an arm 151 extending from foot pedal front end 31 (or rear end 33). Located below arm 151 is a push-button type switch 153 for actuation by foot pedal 17 where the output electrical line 155 is connected into the computer (not shown).

While the invention has been described with reference to a particular embodiment thereof, those skilled in the art will be able to make various modifications to the described embodiment of the invention without departing from the true spirit and scope thereof. It is intended that all combinations of elements and steps which perform substantially the same function in substantially the same way to achieve substantially the same result are within the scope of this invention.

What is claimed is:

1. A foot control for a computer mouse-computer pad combination, to move a computer cursor around the computer display monitor, comprising:
a) a foot pedal, having a centralized neutral position, said pedal arranged for movement from said neutral position toward and into two other positions by pressure applied from separate areas of the user's foot;
b) a harness for holding one part of a computer mouse-computer pad combination and moving said harness about a flat plane;
c) means interconnecting said foot pedal with said harness to provide north-south, east-west, oblique and curved movements of said harness about said plane with the pivotal movement of said pedal.

2. The foot control for the computer mouse-computer pad combination of claim 1 wherein said two other positions of said foot pedal are caused by the pitching up and down motion of said foot pedal about a transverse axis.

3. The foot control for the computer mouse-computer pad combination of claim 1 wherein said two other positions of said foot pedal are caused by yawing motion, clockwise and counter-clockwise, of said pedal about a supporting, pivotal connection.

4. The foot control for the computer mouse-computer pad combination of claim 1 wherein said two other positions of said foot pedal are caused by the rolling motion of said foot pedal about a central axis aligned along the long part of said foot pedal.

5. The foot control for the computer mouse-computer pad combination of claim 1 wherein said harness is arranged to hold the mouse of a computer mouse-computer pad combination and moving said mouse about a flat plane in contact with the mouse pad.

6. The foot control for the computer mouse-computer pad combination of claim 1 wherein said harness is arranged to hold the mouse pad of a computer mouse-computer pad combination and moving said pad about a flat plane in contact with the mouse.

7. The foot control for the computer mouse-computer pad combination of claim 1 further including a base located adjacent said foot pedal for supporting said harness for holding one part of a computer mouse-computer pad combination and moving said harness about a flat plane.

8. The foot control for the computer mouse-computer pad combination of claim 7 wherein said means, interconnecting said foot pedal with said harness to provide north-south, east-west, oblique and curved movements of said harness about said plane with the pivotal movement of said foot pedal, is selected from the group consisting of mechanical means, electrical means, and electromechanical means.

9. The foot control for the computer mouse-computer pad combination of claim 8 wherein said mechanical means includes:
a) a base located adjacent said foot pedal for supporting said harness;
b) a plurality of pulleys mounted on said base for rotational movement; and,
c) flexible lines attached to said foot pedals and said harness, about said pulleys, and arranged for moving about said base, as powered by said foot pedal and as directed by said pulleys, to reposition said harness as a function of the movement of said foot pedal.

10. The foot control for the computer mouse-computer pad combination of claim 1 wherein said electrical means includes at least one variable resistor connected to said foot pedal providing a first resistance denoting said neutral position and second and other resistances denoting movement of said foot pedal from said neutral position through to said two other positions.

11. The foot control for the computer mouse-computer pad combination of claim 1 wherein said electrical means includes at least one variable capacitor connected to said foot pedal providing a first capacitance denoting said neutral position and second and other capacitances denoting movement of said foot pedal from said neutral position through to said two other positions.

12. The foot control for the computer mouse-computer pad combination of claim 1 wherein said electrical means includes at least one variable voltage divider connected to said foot pedal providing a first voltage denoting said neutral position and second and other voltages denoting movement of said foot pedal from said neutral position through to said two other positions.

13. A foot control for a computer mouse-computer pad combination, to move a computer cursor around the computer display monitor, comprising:
a) two foot pedals in spaced-apart arrangement, each said foot pedal having centralized neutral positions and each said foot pedals arranged for movement from said neutral position toward and into two other positions by pressure applied from separate areas of each of the user's feet;
b) a harness for holding one part of a computer mouse-computer pad combination and moving said harness about a flat plane;
c) means interconnecting said foot pedals with said harness to provide north-south, east-west, oblique and curved movements of said harness about said plane with the pivotal movement of said foot pedals.

14. The foot control for the computer mouse-computer pad combination of claim 13 wherein said two other positions of each said foot pedals are caused by pitching up and down motion of said foot pedals about transverse axes.

15. The foot control for the computer mouse-computer pad combination of claim 13 wherein said two other positions of said foot pedals are caused by the yawing motion of said foot pedals about pivotal connections.

16. The foot control for the computer mouse-computer pad combination of claim 13 wherein said two other positions of said foot pedals are caused by the rolling motion of said foot pedals about central axes aligned with the long portion of each said foot pedal.

17. The foot control for the computer mouse-computer pad combination of claim 13 wherein said two other positions of said foot pedals are caused by the pitching up and down motion one of said pedals about a transverse axis and the yawing motion of said foot pedals about a pivotal connection.

18. The foot control for the computer mouse-computer pad combination of claim 13 wherein said two other positions of said foot pedals are caused by the pitching up and down motion of one of said foot pedals about a transverse axis and the rolling motion of said other foot pedal about a central axis aligned with the long direction of said other foot pedal.

19. The foot control for the computer mouse-computer pad combination of claim 13 wherein said two other positions of said foot pedals are caused by the rolling motion of one of said foot pedals about a central axis, aligned with the long direction of said foot pedal, and the yawing motion of the other of said foot pedals about a pivotal connection.

20. The foot control for the computer mouse-computer pad combination of claim 13 wherein said harness is arranged to hold the mouse of a computer mouse-computer pad combination to move the mouse about a flat plane in contact with the mouse pad.

21. The foot control for the computer mouse-computer pad combination of claim 13 wherein said harness is arranged to hold the mouse pad of a computer mouse-computer pad combination to move the pad about a flat plane in contact with a mouse.

22. The foot control for the computer mouse-computer pad combination of claim 13 further including a base located between said foot pedals for supporting said harness.

23. The foot control for the computer mouse-computer pad combination of claim 13 wherein said means, interconnecting said foot pedal with said harness is selected from the group consisting of mechanical means, electrical means, and electro-mechanical means.

24. The foot control for the computer mouse-computer pad combination of claim 23 wherein said mechanical means includes:
a) a base located between said foot pedals for supporting said harness and for moving said harness about a flat plane;
b) a plurality of pulleys mounted on said base for rotational movement; and,
c) at least one flexible line attached to said foot pedals and said harness and arranged for moving about said base, as powered by said foot pedals and as directed by said pulleys, to reposition said harness as a function of the movement of said foot pedals.

25. The foot control for the computer mouse-computer pad combination of claim 24 wherein said electrical means includes at least one variable resistor connected to said foot pedal providing a first resistance denoting said neutral position and second and other resistances denoting movement of said foot pedal from said neutral position toward and into said two other positions.

26. The foot control for the computer mouse-computer pad combination of claim 24 wherein said electrical means includes at least one variable capacitor connected to said foot pedal providing a first capacitance denoting said neutral position and second and other capacitances denoting movement of said foot pedal from said neutral position toward and into said two other positions.

27. The foot control for the computer mouse-computer pad combination of claim 24 wherein said electrical means includes at least one variable voltage divider connected to said foot pedal providing a first voltage denoting said neutral position and second and other voltages denoting movement of said foot pedal from said neutral position toward and into said two other positions.

28. The foot control for the computer mouse-computer pad combination of claim 24 further including a base, located between said foot pedals, for supporting said foot pedals thereon and for holding one part of said computer mouse-computer pad combination and moving said harness about a flat plane.

29. A foot control for a computer mouse-computer pad combination, to move a computer cursor around the computer display, comprising:
a) two foot pedals in spaced-apart arrangement, each said foot pedal having a centralized neutral position, each said pedal arranged for movement from said neutral positions toward and into two other positions by pressure applied from separate areas of each foot;
b) a harness for holding one part of a computer mouse-computer pad combination and moving said harness about a flat plane;
c) means interconnecting one of said foot pedals with said harness to provide north-south, east-west, oblique and curved movements of said harness about said plane with the pivotal movement of said pedal; and,
d) means interconnecting the other of said foot pedals to switches for selecting various functions in the computer as a function of the cursor position.
